(19) United States
(12) Patent Application Publication
(10) Pub. No.: US 2012/0215703 A1
(43) Pub. Date: Aug. 23, 2012

(54) PROPERTY VALUE ESTIMATION WITH CATEGORICAL LOCATION VARIABLE PROVIDING NEIGHBORHOOD PROXY

(75) Inventors: WenXiong W. Yao, Rockville, MD (US); Eric Rosenblatt, Derwood, MD (US); Alexei M. Kisselev, Burke, VA (US); Nathan Pieter Den Herder, Falls Church, VA (US); Silviu Cristian Marghescu, Palo Alto, CA (US)

(73) Assignee: Fannie Mae, Washington, DC (US)

(21) Appl. No.: 13/031,852

(22) Filed: Feb. 22, 2011

(51) Int. Cl. G06Q 50/00

(52) U.S. Cl. 705/313

(57) ABSTRACT

Model-based property value estimation with that implements a categorical location variable providing a neighborhood proxy. A regression models the relationship between sale price and a set of explanatory variables. These explanatory variables include a location variable that is defined at a level of granularity such that the location variable acts as a proxy for location within a neighborhood. An infill process remedies the effects of insufficient amounts of location variable data.

### BACKGROUND OF THE INVENTION

1. Field of the Invention

This application relates generally to estimating real estate values, and more particularly to real property value estimation using a regression of variables including a categorical location variable that acts as a proxy for location within a given neighborhood.

2. Description of the Related Art

Although the financial industry implements statistical modeling to estimate the market value of properties, current models are limited.

What is needed is more accurate modeling of property values, with better correlation to neighborhood, and accurate performance even where available data may be below a reliability threshold.

### SUMMARY OF THE INVENTION

According to one aspect of the present invention, the CBG (census block group) in which a property resides is used as a categorical variable in the hedonic equation. The level of granularity of the CBG acts as a proxy for location of a property within a given specific neighborhood, and offers more accurate adjustments and value prediction than, for example, using the larger census block tract as a location variable.

This may entail provision of a modeled appraisal of a home value by accessing property data and performing a regression. The regression models the relationship between sale price and a set of explanatory variables. These explanatory variables include a location variable that is defined at a level of granularity such that the location variable acts as a proxy for location within a neighborhood.

A property may be compared to other properties, and a given property value may be estimated using results of the regression.

According to another aspect, the present invention provides a data infilling process useful for situations where the location variable does not contain sufficient data points. When it is determined that the amount of property data corresponding to a given categorical location is below a threshold sufficient to produce a reliable estimate of a location variable effect for the given categorical location (e.g., CBG), an infill value is assigned as the location variable effect for the given location. Examples include a substitution value, such as the location variable effect as determined at the larger census tract level, or a modeled value, such as one based upon the median market value of homes in the CBG.

The present invention may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property analysis application operates.

FIG. 2 is a flow diagram illustrating an example of a process for modeling comparable properties.

FIG. 3 is a flow diagram illustrating an example of a method for property value estimation that includes a location variable that acts as a local neighborhood proxy, and location variable infilling.

FIG. 4 is a block diagram illustrating an example of a comparable property analysis application.

FIGS. 5A-D are display diagrams illustrating examples of map images and corresponding property grid data generated by the comparable property analysis application.

### DETAILED DESCRIPTION OF THE INVENTION

In the following description, for purposes of explanation, numerous details are set forth, such as flowcharts and system configurations, to provide an understanding of one or more embodiments of the present invention. However, it is and will be apparent to one skilled in the art that these specific details are not required to practice the present invention.

Determining a predicted value may correlate somewhat to the comparable sales approach used by appraisers. By way of overview, the process of determining a predicted value of a subject property using a modeled comparable approach may be as follows:

(1) Adjustment factors are derived from a hedonic equation;

(2) Comparable properties are identified based on their similarity to the subject (i.e., exclusion rules may be applied to limit the number of comparable properties);

(3) Each comparable property is adjusted based on its differences from the subject; and

(4) A predicted value of the subject property is the weighted average of all the adjusted comparables.

Modeling seeks to identify submarkets within large (but varying, within locations) amounts of data, in contrast to the hands on “local knowledge” approach of human appraisers. The exact boundary of each submarket at the national level is unknown, yet it is desirable to have a transparent and consistent definition.

Census tract boundaries may follow visible features, designed to be relatively homogeneous units with respect to population characteristics, economic status, and living conditions at the time of establishment. Census tracts average about 4,000 inhabitants. Yet, given a relatively large size of a typical census tract, the desired level of the homogeneity in terms of relative property values is not achieved. This is because the level of granularity necessary for the location fixed effect estimation in the hedonic price equation necessary is not met by census tract boundaries.

According to one aspect of the present invention, the CBG (census block group) in which a property resides is used as a categorical variable in the hedonic equation. The level of granularity of the CBG acts as a proxy for location of a property within a given specific neighborhood, and offers more accurate adjustments and value prediction than, for example, using the larger census block tract as a location variable.

This may entail provision of a modeled appraisal of a home value by accessing property data and performing a regression. The regression models the relationship between sale price and a set of explanatory variables. These explanatory variables include a location variable that is defined at a level of granularity such that the location variable acts as a proxy for location within a neighborhood.

A property may be compared to other properties, and a given property value may be estimated using results of the regression.

According to another aspect, the present invention provides a data infilling process useful for situations where the location variable does not contain sufficient data points. When it is determined that the amount of property data corresponding to a given categorical location is below a threshold sufficient to produce a reliable estimate of a location variable effect for the given categorical location (e.g., CBG), an infill value is assigned as the location variable effect for the given location. Examples include a substitution value, such as the location variable effect as determined at the larger census tract level, or a modeled value, such as one based upon the median market value of homes in the CBG.

These and other features are further described as follows.

(i) Hedonic Equation

Various models may be used to estimate property values, and to generate the model-chosen comparable properties, including one using a hedonic regression technique.

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Four continuous property characteristics:

(a) log of gross living area (GLA),

(b) log of Lot Size,

(c) log of Age, and

(d) Number of Bathrooms; and

(2) Three fixed effect variables:

(a) location fixed effect (e.g., preferably by Census Block Group (CBG));

(b) Time fixed effect (e.g., measured by 3-month periods (quarters) counting back from the estimation date); and

(c) Foreclosure status fixed effect, which captures the maintenance condition and possible REO discount.

The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH + {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + ɛ \qquad ( Eq . 1 )$$

Preferably, CBG is used as the location fixed effect, and acts as a proxy for neighborhood (i.e., properties within a given CBG are deemed to be within a neighborhood for purposes of the model).

The explanatory variables may vary. For example, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

(i.b) Infilling

Regarding estimation of fixed location effects, the build sample for the hedonic equation regression in a given county is constructed to allow for a statistically sound estimation of price coefficients. Yet the property transaction data is not necessarily uniformly distributed over all of a county's CBGs, as some of them may have too few data points to produce a reliable estimate. This issue is addressed by an infilling process, which replaces missing or deemed unreliable CBG-level location effects with infill values calculated from either a tract-level fixed effect or continuous median market value, as described below.

For the purpose of infilling, a location effect can be isolated from the regression equation by defining a so-called offset function, such as that expressed in the following Equation (Eq. 2):

$${LOC}_{OFFSET} = ln ( p ) - ( \begin{matrix}{β}_{gla} \cdot ln ( GLA ) + {β}_{lot} \cdot ln ( LOT ) + {β}_{age} \cdot ln ( AGE ) + \\ {β}_{bath} \cdot BATH + {\sum }_{j = 1}^{{N}_{QTR}} {TIME}_{j} + {\sum }_{k = \{ 0 , 1 \}} {FCL}_{k}\end{matrix} ) \qquad ( Eq . 2 )$$

This allows a production of alternative sets of location effects that may be used interchangeably with CBG-level ‘dummies’ by estimating the regression with LOC_{OFFSET}, as the dependent variable, and any set of suitable predictors without the need to re-estimate the regression on the full price equation, since all other effects (i.e., GLA, LOT, AGE, BATH, TIME, and FCL) are kept fixed in this example.

A price equation with the CBG-level location effect is used to estimate a full price equation regression to produce the parameter values for all predictors (GLA, LOT, AGE, BATH, TIME, FCL, and LOC^{CBG}), while the offset function (LOC_{OFFSET}) is calculated to feed into the infilling logic.

An infill with tract-level location effect is us to estimate potential infill values from running a regression according to the following equation:

$${LOC}_{OFFSET} = {\sum }_{i = 1}^{{N}_{TRACT}} {LOC}_{i}^{TRACT} + ɛ \qquad ( Eq . 3 )$$

This results in a set of tract-level location fixed effects LOC^{TRACT}, which, provided the appropriate sample size in a given census tract, can be used to replace missing or unreliable values of CBG-level location effect.

The distribution of the build sample among the census tracts in a given county does not always produce a reliable value of a location effect estimate because tract is a different granularity choice for addressing the issues with CBG-level location effects. Thus, in the infilling process, the infill may be calculated with ×β's based on continuous MMV values.

Further, isolated location effects are modeled using a continuous predictor variable, such as a CBG-level median market value (MMV) consistent with census data (e.g., the 2000 or 2010 U.S. Census. The following equation may be implemented in this regard:

LOC_{OFFSET}=βₘₘᵥ·MMV+ε (Eq. 4)

Given that the MMV in this equation is a continuous variable, it allows the calculation of a prediction for the location effect for any CBG in a county, by multiplying the βₘₘᵥ from the regression above by the corresponding value of the MMV for that particular CBG.

Implementing CBG-level MMV as a predictor for the location effect infilling logic has been determined as appropriate because of the high level of nationwide coverage of that value.

Following the logic described above, the location effect infilling process for any CBGᵢ (within a given submarket of a given county) may be as follows:

if N_{OBS}(CBGᵢ)<10 then LOCᵢ^{CBG}=LOCⱼ^{TRACT}, where CBG,εTRACTⱼ

if N_{OBS}(TRACTⱼ)<30 then LOCᵢ^{CBG}=βₘₘᵥ·MMV(CBGᵢ) (Eq. 5)

These and other equations are examples, and although the noted predetermined observational thresholds for the number of CBG and Tract data points are noted, there may be departures depending upon data and conditions.

As an alternative to the CBG, a proxy of a local neighborhood may be a school attendance zone, defined as a unique combination of elementary, middle, and high schools assigned to any given property. One test of school attendance zone, using Fairfax County, produced slightly inferior results, somewhat comparable to the performance of tract-level location effect. However, this does not mean that this and other proxies may be implemented.

Furthermore, based on the test performed in Fairfax County, prediction accuracy of CBG-level location effect may be matched by clustering a county map of property transactions on XY-plane using a k-means procedure, provided that the number of resulting clusters is approximately equal to the number of CBGs in that county. The clear disadvantage of the clusters comparing to the CBGs is that they have no natural boundaries and no common sense meaning attached to them, besides requiring additional computation without providing any lift in the performance.

Although currently CBG is a preferred local neighborhood proxy, it should be understood that alternative proxies may be implemented.

(ii) Exclusion Rules

In processes where a set of comparables are determined, comparable selection rules may initially be used to narrow the pool of comps to exclude the properties which are determined to be insufficiently similar to the subject.

A comparable property should be located in a relative vicinity of the subject and should be sold relatively recently; it should also be of similar size and age and sit on a commensurate parcel of land. The “N” comparables that pass through the exclusion rules are used for further analysis and value prediction.

For example, the following rules may be used to exclude comparables pursuant to narrowing the pool:

(1) Neighborhood: comps must be located in the Census Tract of the subject and its immediate neighboring tracts;

(2) Time: comps must be sales within twelve months of the effective date of appraisal or sale;

(3) GLA must be within a defined range, for example:

$$\frac{2}{3} \leq \frac{{GLA}_{S}}{{GLA}_{C}} \leq \frac{3}{2}$$

(4) Age similarity may be determined according to the following Table 1:

TABLE 1

| Subject Age | 0-2 | 3-5 | 6-10 | 11-20 | 21-40 | 41-65 | 65+ |
|---|---|---|---|---|---|---|---|
| Acceptable Comp Age | 0-5 | 0-10 | 2-20 | 5-40 | 11-65 | 15-80 | 45+ |

(5) Lot size similarity may be determined according to the following Table 2:

TABLE 2

| | | | | |
|---|---|---|---|---|
| Subject Lot size | <2000 sqft | 2000-4000 sqft | 4000 sqft-3 acres | >3 acres |
| Acceptable Comp Lot | 1-4000 sqft | 1-8000 sqft | $\frac{2}{5} ≦ \frac{{LOT}_{S}}{{LOT}_{C}} ≦ \frac{5}{2}$ | >1 acre |

These exclusion rules are provided by way of example. There may be a set of exclusion rules that add variables, that omit one or more the described variables, or that use different thresholds or ranges.

(iii) Adjustment of Comps

Given the pool of comps selected by the model, the sale price of each comp may then be adjusted to reflect the difference between a given comp and the subject in each of the characteristics used in the hedonic price equation.

For example, individual adjustments are given by the following set of equations (6):

A_{gla}=exp└(ln(GLA_{S})−ln(GLA_{C}))·β_{gla}┘;

Aₗₒₜ=exp[(ln(LOT_{S})−ln(LOT_{C}))·βₗₒₜ];

A_{age}=exp└(ln(AGE_{S})−ln(AGE_{C}))·β_{age}┘;

A_{bath}=exp└(BATH_{S}−BATH_{C})·β_{age}┘; (Eq. 6)

A_{loc}=exp[LOC_{S}−LOC_{C}];

Aₜᵢₘₑ=exp[TIME_{S}−TIME_{C}]; and

A_{fcl}=exp[FCL_{S}−FCL_{C}],

where coefficients βgla, βlot, βage, βbath, LOC, TIME, FCL are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl \}} {A}_{i} = {p}_{C} \cdot {A}_{TOTAL} \qquad ( Eq . 7 )$$

(iv) Weighting of Comps and Value Prediction

Because of unknown neighborhood boundaries and potentially missing data, the pool of comparables will likely include more than are necessary for the best value prediction in most markets. The adjustments described above can be quite large given the differences between the subject property and comparable properties. Accordingly, rank ordering and weighting are also useful for the purpose of value prediction.

The economic distance D_{eco} between the subject property and a given comp may be described as a function of the differences between them as measured in dollar value for a variety of characteristics, according to the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl \}} {( {A}_{i} - 1 )}^{2}} \qquad ( Eq . 8 )$$

The comps are then weighted. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} \qquad ( Eq . 9 )$$

where D_{geo} is a measure of a geographic distance between the comp and the subject, defined as a piece-wise function:

$${D}_{SC}^{geo} = \{ \begin{matrix}0.1 & if & {d}_{SC} < 0.1 mi \\ {d}_{SC} & if & 0.1 mi \leq {d}_{SC} \leq 1.0 mi \\ 1.0 + \sqrt{{d}_{SC} - 1.0} & if & {d}_{SC} > 1.0 mi ,\end{matrix} \qquad ( Eq . 10 )$$

and dT is a down-weighting age of comp sale factor

$${dT}_{SC} = \{ \begin{matrix}1.00 & if & ( 0 , 90 ] days \\ 1.25 & if & ( 90 , 180 ] days \\ 2.00 & if & ( 180 , 270 ] days \\ 2.50 & if & ( 270 , 365 ] days .\end{matrix} \qquad ( Eq . 11 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 12 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

(v) Listing and Mapping of Comparable Properties

The comparable properties may then be listed according to the weighting, or a ranking from the highest weighted comparable property to the lowest. This listing may be variously limited to accommodate listing them within a display area. For example, a default setting might be 20 comparable properties. The overall list of comparable properties includes, of course, the model-chosen comparable properties. The overall list will also presumably include all of the appraiser-chosen comparables, although if the comparables are chosen in particularly poor fashion, this may not be the case. In that instance the appraiser-chosen comparables may be listed at the bottom of the ranked listing, potentially with indicia that the model failed to even identify them as being within the appropriate pool of comparables.

According to another aspect, mapping and analytical tools that implement the comparable model are provided. Mapping features allow the subject property and comparable properties to be concurrently displayed. Additionally, a table or grid of data for the subject properties is concurrently displayable so that the list of comparables can be manipulated, with the indicators on the map image updating accordingly.

For example, mapping features include the capability to display the boundaries of census units, school attendance zones, neighborhoods, as well as statistical information such as median home values, average home age, etc.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

With further reference to the figures, examples of environments and particular embodiments implementing the ranking and displaying of comparable properties are now further described.

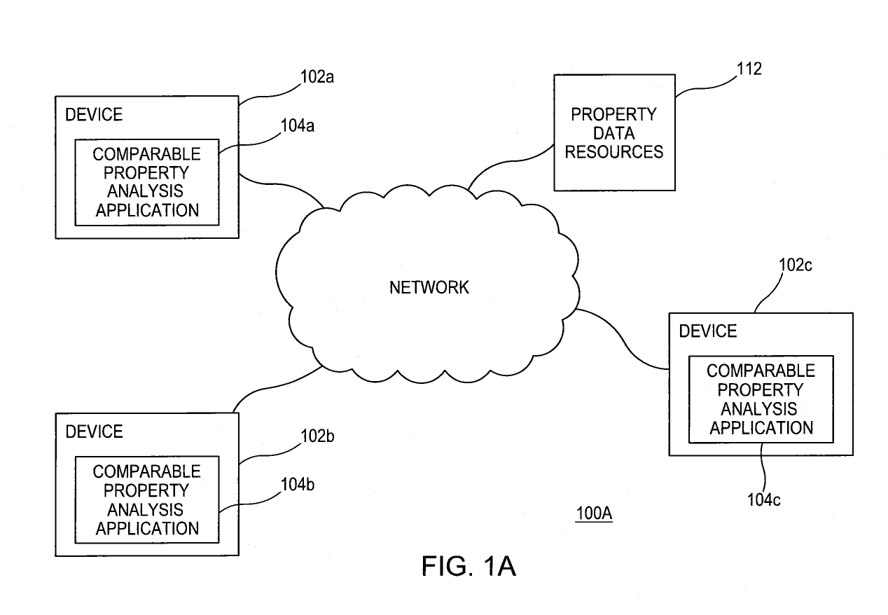

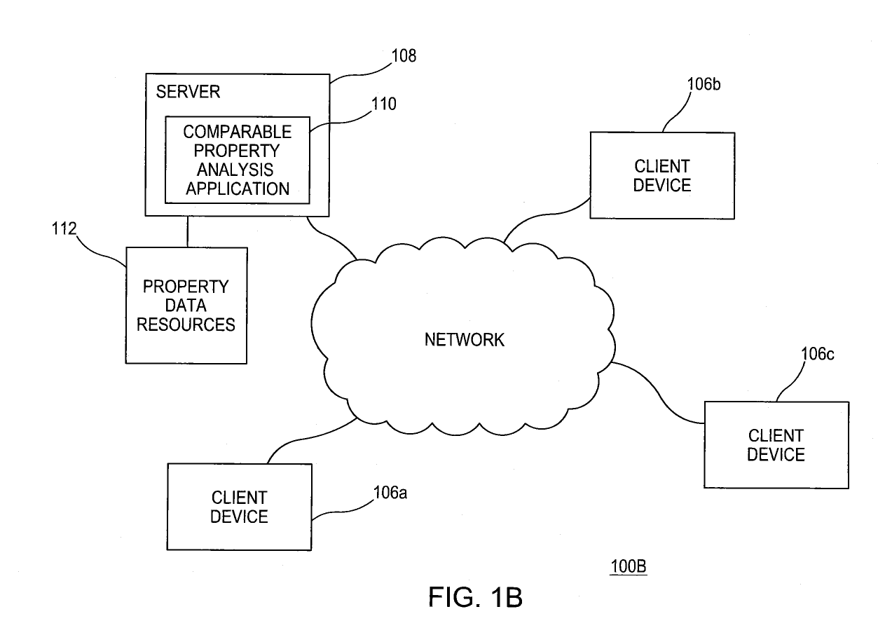

FIGS. 1A-B are block diagrams illustrating examples of systems 100A-B in which a comparable property analysis application operates.

FIG. 1A illustrates several user devices 102a-c each having a comparable property analysis application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property analysis application 104a-c is an application that is installed on the user device 102a-c. For example, the user device 102a-c may be configured with a web browser application, with the application configured to run in the context of the functionality of the browser application. This configuration may also implement a network architecture wherein the comparable property analysis applications 104a-c provide, share and rely upon the comparable property analysis application 104a-c functionality.

As an alternative, as illustrated in FIG. 1B, the computing devices 106a-c may respectively access a server 108, such as through conventional web browsing, with the server 108 providing the comparable property analysis application 110 for access by the client computing devices 106a-c. As another alternative, the functionality may be divided between the computing devices and server. Finally, of course, a single computing device may be independent configured to include the comparable property analysis application.

As illustrated in FIGS. 1A-B, property data resources 110 are typically accessed externally for use by the comparable property analysis application, since the amount of property data is rather voluminous, and since the application is configured to allow access to any county or local area in a very large geographical area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property analysis application accesses and retrieves the property data from these resources in support of the modeling of comparable properties as well as the rendering of map images of subject properties and corresponding comparable properties, and the display of supportive data (e.g., in grid form) in association with the map images.

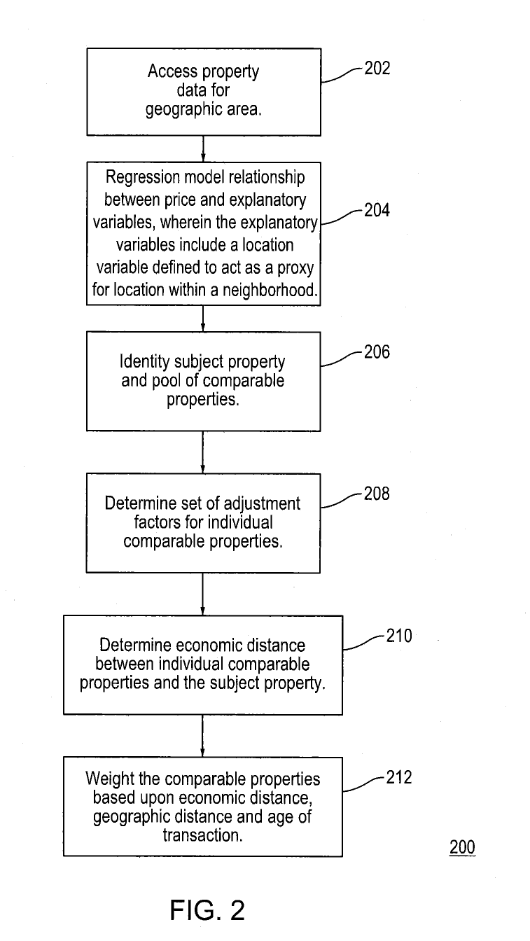

FIG. 2 is a flow diagram illustrating an example of a process 200 for modeling comparable properties, which may be performed by the comparable property analysis application.

As has been described, the application accesses 202 property data. This is preferably tailored at a geographical area of interest in which a subject property is located (e.g., county). A regression 204 modeling the relationship between price and explanatory variables is then performed on the accessed data. Although various alternatives may be applied, a preferred regression is that described above, wherein the explanatory variables are the four property characteristics (GLA, lot size, age, number of bathrooms) as well as the categorical fixed effects (location, time, foreclosure status). Additionally, as described above, the explanatory variables preferably include a location variable defined to act as a proxy for location within a neighborhood, such as CBG.

A subject property within the county is identified 206 as is a pool of comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

The pool of comparable properties may be initially defined using exclusion rules. This limits the unwieldy number of comparables that would likely be present if the entire county level data were included in the modeling of the comparables.

Although a variety of exclusion rules can be used, in one example they may include one or more of the following: (1) limiting the comparable properties to those within the same census tract as the subject property (or, the same census tract and any adjacent tracts); (2) including only comparable properties where the transaction (e.g., sale) is within 12 months of the effective date of the appraisal or transaction (sale); (3) requiring GLA to be within a range including that of the subject property (e.g., +/−50% of the GLA of the subject property); (4) requiring the age of the comparable properties to be within an assigned range as determined by the age of the subject property (e.g., as described previously); and/or (5) requiring the lot size for the comparable properties to be within an assigned range as determined by the lot size of the subject property (e.g., as described previously).

Once the pool is so-limited, a set of adjustment factors is determined 208 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 208, the “economic distance” between the subject property and respective individual comparable properties is determined 210. The economic distance is preferably constituted as a quantified value representative of the estimated price difference between the two properties as determined from the set of adjustment factors for each of the explanatory variables.

Following determining of the economic distance, the comparable properties are weighted 212 in support of generating a ranking of the comparable properties according to the model. A preferred weighting, described previously, entails a function inversely proportional to the economic distance, geographic distance and age of transaction (typically sale) of the comparable property from the subject property.

The weights may further be used to calculate an estimated price of the subject property comprising a weighted average of the adjusted price of all of the comparable properties.

Once the model has performed the regression, adjustments and weighting of comparables, the information is conveyed to the user in the form of grid and map image displays to allow convenient and comprehensive review and analysis of the set of comparables.

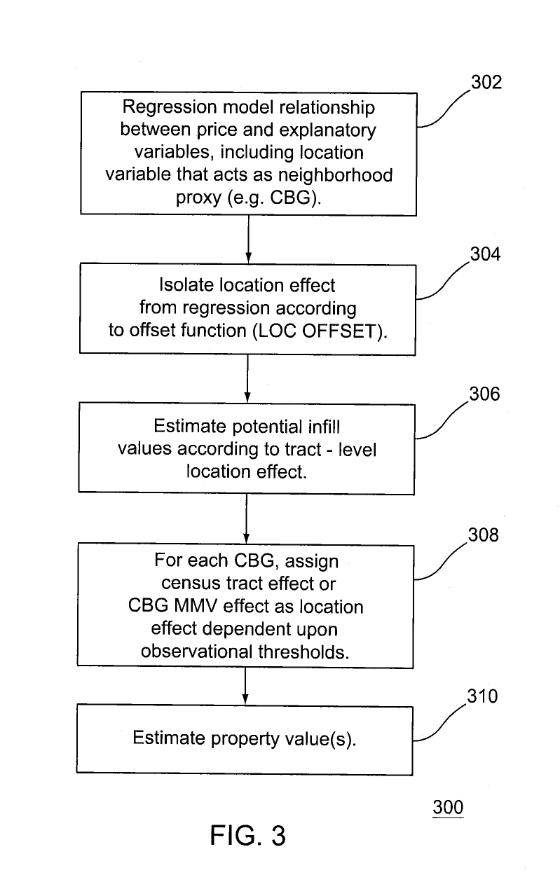

FIG. 3 is a flow diagram illustrating an example of a method 300 for property value estimation that includes a location variable that acts as a local neighborhood proxy.

Initially, the estimation process entails performing a regression 302 between price and explanatory variables, including a location variable that acts as a neighborhood proxy. In the example described above, which need not be repeated in detail, the regression implements a number of explanatory variables, particularly CBG as the location variable.

The location effect is then isolated 304 from the regression according to an offset function, such as that described in connection with the offset function described above (LOC_{OFFSET}, Eq. 2). This allows alternative location effects to be used interchangeably with CBG-level dummies by estimating the regression with LOC_{OFFSET}, as the dependent variable, and any set of suitable predictors without the need to re-estimate the regression on the full price equation since other effects may be kept fixed.

Potential infill values are then estimated 306 according to a tract-level location effect. This, essentially, entails running a regression that applies the tract-level location effect for the offset function values. (See, e.g., Eq. 3 above).

Then, the infill process continues by assigning 308, for each CBG, either a substitute effect (e.g., the tract-level effect as the location variable) or a modeled effect (e.g., the CBG median market value as the location variable) dependent upon observational thresholds. By way of example, if there are less than a predetermined number of observations in the CBG, then the tract-level effect is applied; if there are less than another predetermined number of observations in the Tract, then the modeled effect is applied. (See, e.g., Eq. 5 above). Finally, one or more property values may be estimated 310 using the regression treated according to the infill process.

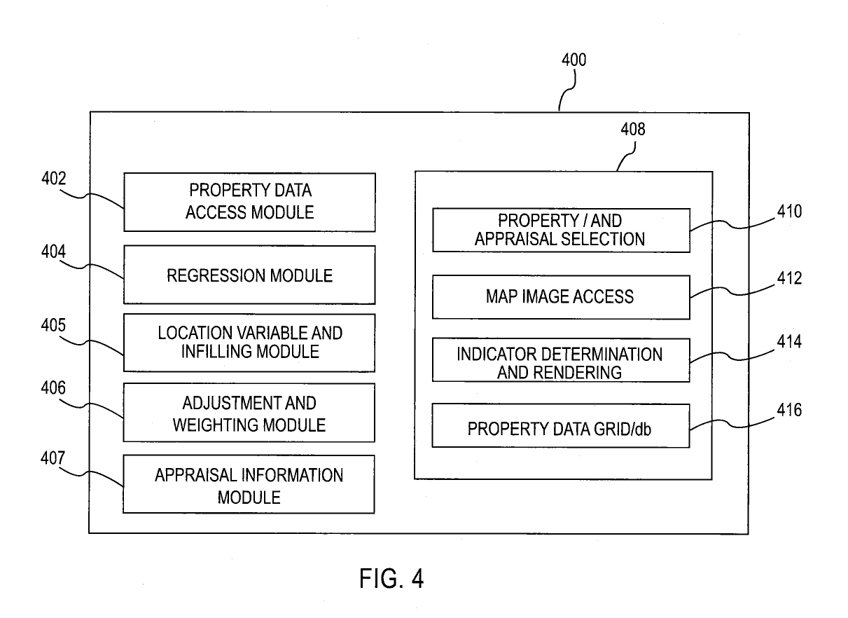

FIG. 4 is a block diagram illustrating an example of a comparable property analysis application 400. The application 400 preferably comprises program code that is stored on a computer readable medium (e.g., compact disk, hard disk, etc.) and that is executable by a processor to perform operations in support of modeling and mapping comparable properties.

According to one aspect, the application 400 includes program code executable to perform operations of accessing property data corresponding to a geographical area, and performing a regression based upon the property data, with the regression modeling the relationship between price and explanatory variables. The explanatory variables preferably include a location variable that acts as a proxy for neighborhood location, such as CBG. Additionally, an infilling process assigns infill values for the location variable where appropriate, such as by a substitute effect or modeled effect as described further above.

When it is desired to identify a set of model-chosen comparable properties, a subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The application 400 also includes program code for displaying a map image corresponding to the geographical area, and displaying indicators on the map image indicative of the subject property and at least one of the plurality of comparable properties, as well as ranking the plurality of comparable properties based upon the weighting, and displaying a text listing of the plurality of comparable properties according to the ranking.

The application 400 also includes program code for ranking and displaying comparable properties. Appraisal information is accessed, so as to identify a given subject property and corresponding appraiser-chosen comparable properties for the subject property. The modeling functionality previously described determines a plurality of model-chosen comparable properties based upon the appropriateness of each of the plurality of comparable properties as comparables for the subject property. Thereby, a map image corresponding to the geographical area is displayed, as well as indicators on the map image indicative of the subject property, at least one of the plurality of appraiser-chosen comparable properties, and at least one of the model-chosen comparable properties. In addition to the map image, the application 400 determines the ranked listing of comparable properties including the plurality of model-chosen comparable properties and the plurality of appraiser-chosen comparable properties, and displaying the ranked listing of comparable properties concurrently with the map image, such as in the described grid form.

The comparable property analysis application 400 is preferably provided as software, but may alternatively be provided as hardware or firmware, or any combination of software, hardware and/or firmware. The application 400 is configured to provide the comparable property modeling, appraisal results comparing and corresponding mapping functionality described herein. Although one modular breakdown of the application 400 is offered, it should be understood that the same functionality may be provided using fewer, greater or differently named modules.

The example of the comparable property analysis application 400 of FIG. 4 includes a property data access module 402, regression module 404, location variable and infilling module 405, adjustment and weighting module 406, appraisal information module 407, and UI module 408, with the UI module 408 further including a property and appraisal selection module 410, map image access module 412, indicator determining and rendering module 414 and property data grid/DB module 416.

The property data access module 402 includes program code for carrying access and management of the property data, whether from internal or external resources. The regression module 404 includes program code for carrying out the regression upon the accessed property data, according to the regression algorithm described above, and produces corresponding results such as the determination of regression coefficients and other data at the country (or other) level as appropriate for a subject property. The regression module 404 may implement any conventional code for carrying out the regression given the described explanatory variables and property data. The location variable and infilling module 405 includes program code for managing the implementation of the location variable and performing the infilling process.

The adjustment and weighting module 406 is configured to apply the exclusion rules, and to calculate the set of adjustment factors for the individual comparables, the economic distance, and the weighting of the comparables.

The appraisal information module 407 may be a stand-alone database or may organize access to a variety of external databases of appraisal information. The appraisal information is typically in the form of appraisal reports for subject properties, wherein a set of comparable properties chosen by an appraiser is listed. The appraisal information may be retrieved based upon a variety of criteria, including search by subject property, identification number, or characteristics (appraiser ID, vendor, date, etc.).

The UI module 408 manages the display and receipt of information to provide the described functionality. It includes a property and appraisal selection module 410, to manage the interfaces and input used to identify one or more subject properties and corresponding appraisal information. The map image access module 412 accesses mapping functions and manages the depiction of the map images as well as the indicators of the subject property and the comparable properties. The indicator determination and rendering module 414 is configured to manage which indicators should be indicated on the map image depending upon the current map image, the weighted ranking of the comparables and predetermined settings or user input. The property data grid/DB 416 manages the data set corresponding to a current session, including the subject property and pool of comparable properties. It is configured as a database that allows the property data for the properties to be displayed in a tabular or grid format, with various sorting according to the property characteristics, economic distance, geographical distance, time, etc.

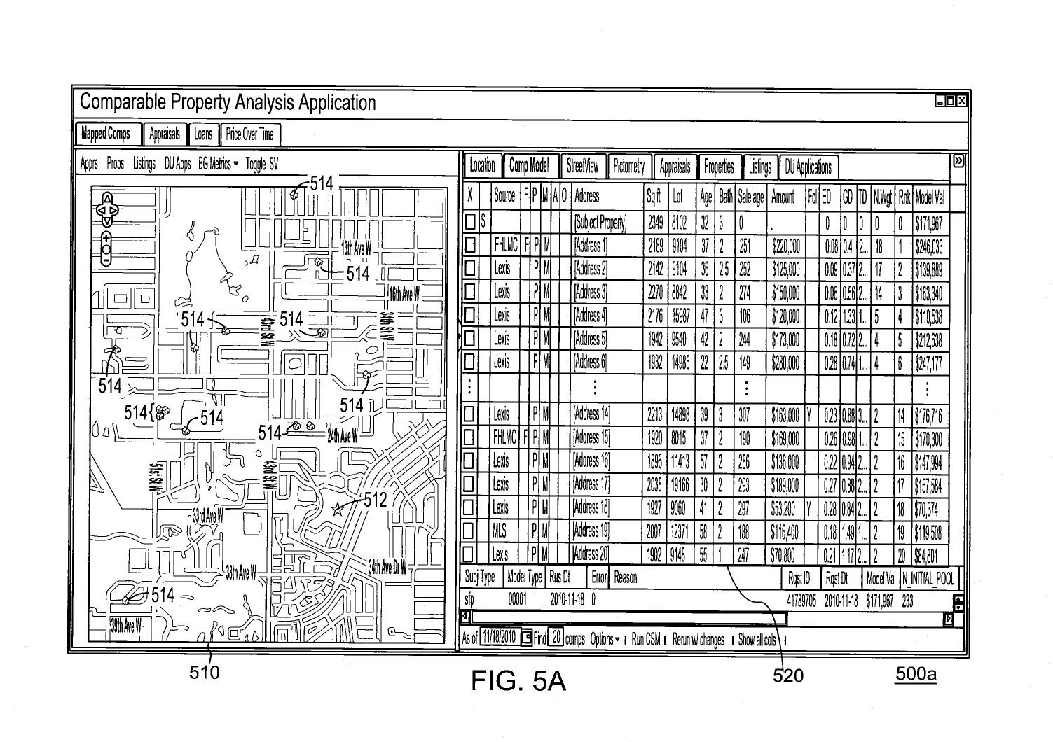

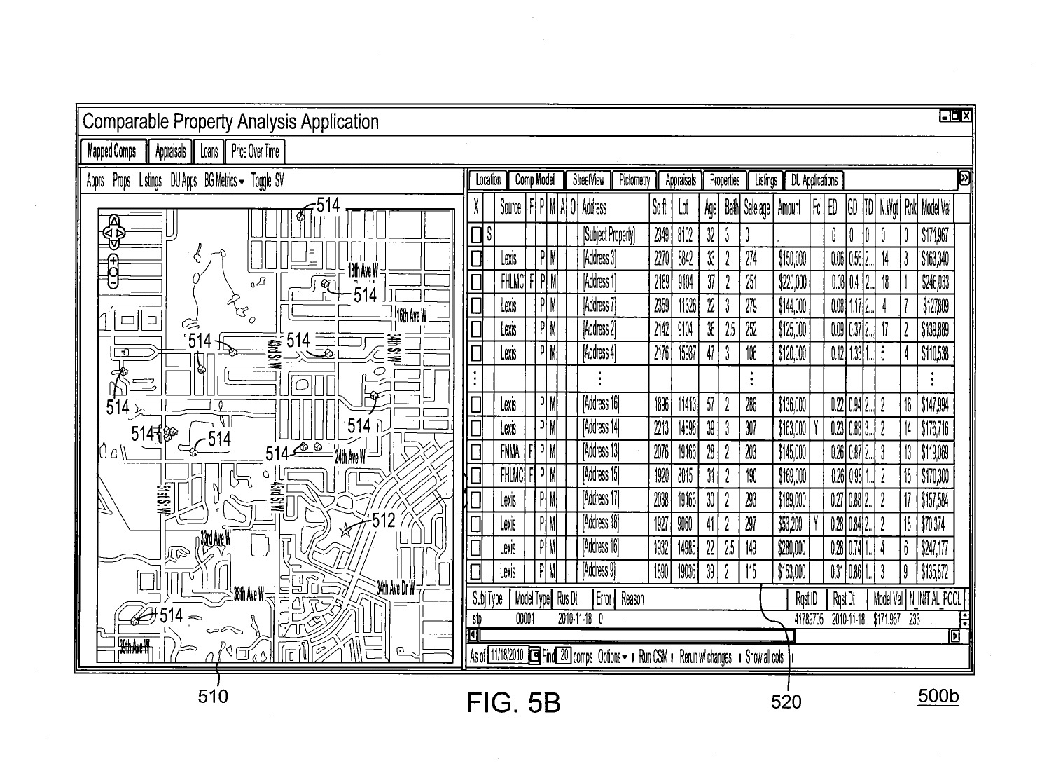

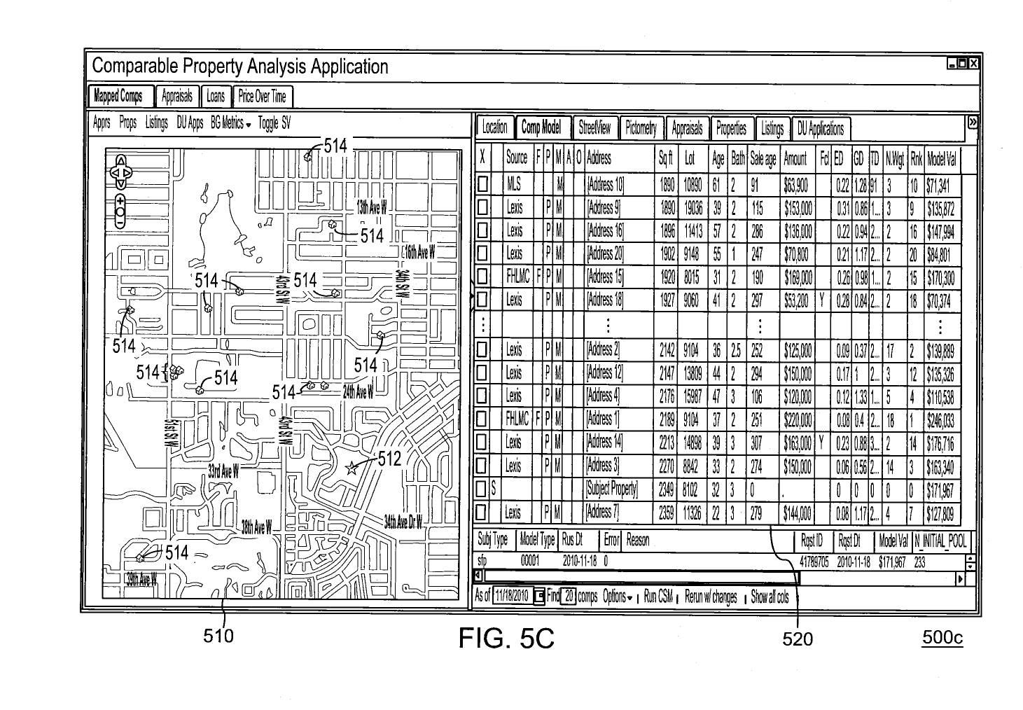

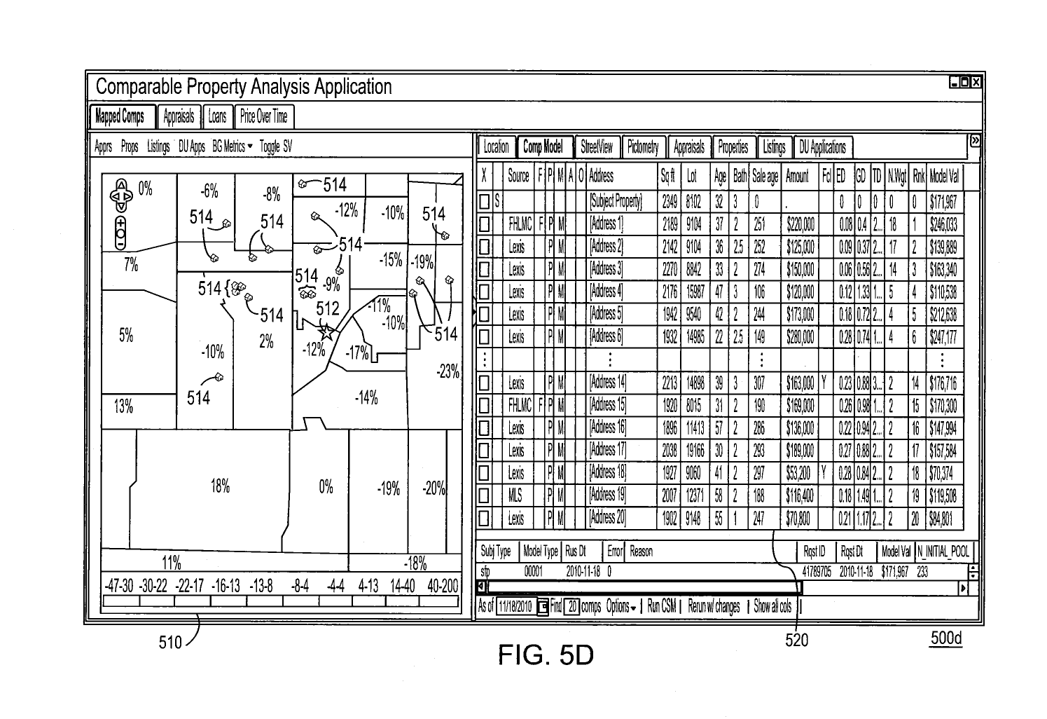

FIGS. 5A-D are display diagrams illustrating examples of map images and corresponding property grid data generated by the comparable property analysis application.

For example, FIG. 5A illustrates an example of a display screen 500a that concurrently displays a map image 510 and a corresponding property data grid 520. This screen may be displayed following selection of a subject property by a user followed by prompting a running of the comparable property model, which identifies the comparable properties, determines adjustment factors, determines economic distance and weights the comparable properties, such as described above.

The map image 510 depicts a region that can be manipulated to show a larger or smaller area, or moved to shift the center of the map image, in convention fashion. This allows the user to review the location of the subject property 512 and corresponding comps 514 at any desired level of granularity. This map image 510 may be separately viewed on a full screen, or may be illustrated alongside the property data grid 520 as shown.

The property grid data 520 contains a listing of details about the subject property and the comparable properties, as well as various information fields. The fields include an identifier field (e.g., “S” indicates the subject property), the source of data for the property (“Source”), the address of the property (“Address”), the square footage (“Sq Ft”), the lot size (“Lot”), the age of the property (“Age”), the number of bathrooms (“Bath”), the age of the prior sale (“Sale Age”), the prior sale amount (“Amount”), the foreclosure status (“FCL”, y/n), the economic distance (“ED”), geographic distance (“GD”) and time distance (“TD”, e.g., as measured in days) factors as described above, the weight (“N. Wgt”), the ranking by weight (“Rnk”), and the valuation as determined from the comparable sales model (“Model Val”).

The map image 510 allows the user to place a cursor over any of the illustrated properties to prompt highlighting of information for that property and other information. Additionally, the listing of comparables in the property grid data 520 can be updated according to any of the listed columns. For example, the display screen 500b in FIG. 5B illustrates the listing sorted by the economic distance, and the display screen 500c in FIG. 5C illustrates sorting according to the square footage of the properties. The grid data can be variously sorted to allow the user to review how the subject property compares to the listed comparable properties.

The map image 510 is divided into regions to help further assess the location of the subject property and corresponding properties. FIG. 5D illustrates the map image 510 updated to indicate several Census Block Group (CBG) regions 516 in the map image 510. The various CBGs 516 are illustrated as separated by dark lines. Additionally, within each CBG 516 the map image is updated to indicate a relative adjustment as compared to a county average for each CBG. This helps the user to further assess how the subject property relates to the comparable properties, with the CBG acting as a proxy for neighborhood and well-delineated on the map image for concurrent visual observation.

The user may variously update the map image and manipulate the property data grid in order to review and assess and subject property and the corresponding comparable properties in a fashion that is both flexible and comprehensive.

Thus embodiments of the present invention produce and provide methods, articles of manufacture and apparatus for estimating property values. Although the present invention has been described in considerable detail with reference to certain embodiments, the invention may be variously embodied without departing from the spirit or scope of the invention. Therefore, the following claims should not be limited to the description of the embodiments contained herein in any way.

1. A method for estimating property values, the method comprising:
accessing property data;
performing a regression based upon the property data, the regression modeling the relationship between sale price and a set of explanatory variables, the set of explanatory variables comprising a location variable that is defined at a level of granularity such that the location variable acts as a proxy for location within a neighborhood; and
estimating a given property value using results of the regression.

2. The method of claim 1, wherein the explanatory variables include gross living area, lot size, age, and number of bathrooms.

3. The method of claim 1, wherein the level of granularity of the location variable is an area smaller than that defined by a census block tract.

4. The method of claim 1, wherein the location variable is defined as location within a census block group.

5. The method of claim 4, wherein the explanatory variables further comprise a time period variable and a foreclosure status variable.

6. The method of claim 1, further comprising:
determining that the amount of property data corresponding to a given categorical location is below a threshold sufficient to produce a reliable estimate of a location variable effect for the given categorical location; and
assigning an infill value as the location variable effect for the given location.

7. The method of claim 4, further comprising:
determining that the amount of property data corresponding to a given census block group is below a threshold sufficient to produce a reliable estimate of a location variable effect for the given census block group; and
assigning an infill value as the location variable effect for the given census block group.

8. The method of claim 7, wherein the infill value comprises a substitute effect, wherein the substitute effect is a census block tract level effect.

9. The method of claim 7, wherein the infill value comprises a modeled effect that is based upon median market value within the given census block group.

10. A computer program product for estimating property values, the computer program product comprising a computer readable medium having program code stored thereon, the program code being executable to perform operations comprising:
accessing property data;
performing a regression based upon the property data, the regression modeling the relationship between sale price and a set of explanatory variables, the set of explanatory variables comprising a location variable that is defined at a level of granularity such that the location variable acts as a proxy for location within a neighborhood; and
estimating a given property value using results of the regression.

11. The computer program product of claim 10, wherein the explanatory variables include gross living area, lot size, age, and number of bathrooms.

12. The computer program product of claim 10, wherein the level of granularity of the location variable is an area smaller than that defined by a census block tract.

13. The computer program product of claim 10, wherein the location variable is defined as location within a census block group.

14. The computer program product of claim 13, wherein the explanatory variables further comprise a time period variable and a foreclosure status variable.

15. The computer program product of claim 10, wherein the operations further comprise:
determining that the amount of property data corresponding to a given categorical location is below a threshold sufficient to produce a reliable estimate of a location variable effect for the given categorical location; and
assigning an infill value as the location variable effect for the given location.

16. The computer program product of claim 13, wherein the operations further comprise:
determining that the amount of property data corresponding to a given census block group is below a threshold sufficient to produce a reliable estimate of a location variable effect for the given census block group; and
assigning an infill value as the location variable effect for the given census block group.

17. The computer program product of claim 16, wherein the infill value comprises a substitute effect, wherein the substitute effect is a census block tract level effect.

18. The computer program product of claim 16, wherein the infill value comprises a modeled effect that is based upon median market value within the given census block group.

19. An apparatus for estimating property values, the apparatus comprising:
means for accessing property data;
means for performing a regression based upon the property data, the regression modeling the relationship between sale price and a set of explanatory variables, the set of explanatory variables comprising a location variable that is defined at a level of granularity such that the location variable acts as a proxy for location within a neighborhood; and
means for estimating a given property value using results of the regression.

20. The apparatus of claim 19, further comprising:
means for determining that the amount of property data corresponding to a given categorical location is below a threshold sufficient to produce a reliable estimate of a location variable effect for the given categorical location; and
means for assigning an infill value as the location variable effect for the given location.
